(19) United States
(12) Patent Application Publication
(10) Pub. No.: US 2003/0228884 A1
(43) Pub. Date: Dec. 11, 2003

(54) Two folding mobile telephone and mobile telephone

(76) Inventors: Hiroshi Iwai, Osaka (JP); Atsushi Yamamoto, Osaka (JP); Koichi Ogawa, Osaka (JP); Kenichi Yamada, Kanagawa (JP)

Correspondence Address: RATNERPRESTIA, P O BOX 980, VALLEY FORGE, PA, 19482-0980, US

(21) Appl. No.: 10/441,414

(22) Filed: May 20, 2003

(30) Foreign Application Priority Data
May 23, 2002 (JP) 2002-149801

(51) Int. Cl. H04M 1/00; H04B 1/38

(52) U.S. Cl. 455/550.1; 455/575.3; 455/575.7; 455/562.1; 455/566

(57) ABSTRACT

A conventional two folding mobile telephone has a problem that performances are deteriorated by decreasing the two folding mobile telephone in thickness. A two folding mobile telephone constituted by connecting a first housing and a second housing each other so that inside principal planes of the housings are faced each other and closed, in which the angle of aperture formed between the inside of a virtual plane orthogonal to a direction in which the directivity of an audio signal of a speaker is maximized and the inside of a plane including an grounding plate is kept at an angle larger than 165° by temporarily fixing a fixing mechanism and the virtual plane is substantially the same as or parallel with a plane including a voice output plane of the speaker and a display screen for displaying information.

### BACKGROUND OF THE INVENTION

1. Field of the Invention

The present invention relates to a mobile telephone such as a two folding mobile telephone.

2. Related Art of the Invention

In recent years, mobile telephones have been widely used as an information terminal having not only a talking function of a telephone but also an information communicating function using the Internet such as the access to a web site or use of an electronic mail.

Mobile telephones of this type usable as an information terminal require a display screen for displaying information as an image. To secure a large display screen and maintain the portability, a two folding type constituted by separately setting a display screen and keys for inputting data to two housings which can be collapsed is the mainstream as a present mobile telephone.

FIGS. 12(a) to 12(c) and FIGS. 13(a) and 13(b) show a conventional two folding mobile telephone (for example, see Japanese Patent Publication No. 2821333). As shown in FIGS. 12 and 13, a mobile telephone 1300 has a first housing 1310 with an input section 1311 such as a ten-key pad and the like set on its inside principal plane and a second housing 1320 with a display screen 1321 set on its inside principal plane.

A voice input plane 1312 having a built-in microphone for inputting voices is formed on the inside principal plane of the first housing 1310 in addition to the input section 1311 and moreover, hinge brackets 1313a and 1313b to be rotatably connected with the second housing are set to positions opposite to the voice input plane 1312 at the both sides of the input section 1311. Moreover, a retractable helical antenna 1314 is set nearby the outside principal plane of the first housing 1310 and an grounding plate 1315 for earthing various sections of internal circuits of the mobile telephone is built in the first housing 1310. The position in which the grounding plate 1315 is built is a position at which the thickness of the first housing is substantially halved.

Furthermore, a voice output plane 1322 storing a loudspeaker for outputting voices is set to the inside principal plane of the second housing 1320 in addition to the display screen 1321 and a hinge arm 1323 for rotatably connecting the second housing 1320 with the first housing 1310 is set at an end portion of the second housing 1320 opposite to the voice output plane 1322 at the side of the display screen 1321.

As shown in FIGS. 12 and 13, the first housing 1310 and the second housing 1320 are connected each other because the hinge arm 1323 is fitted between the hinge brackets 1313a and 1313b and rotatably movable in the directions of the arrows in FIGS. 12 and 13. In this case, when the first housing 1310 with the hinge arm set on it rotates up to a predetermined angle, the rotation of the housing 1310 is stopped by a stopper 1316 formed at an end of the rotating first housing 1310.

As shown in FIGS. 13(a) and 13(b), when the above two folding mobile telephone 1300 is not operated, it is possible to collapse the telephone 1300 so that the inside principal planes of the both housings are faced each other. Thus, the portability is improved and a large display screen can be secured.

Though not illustrated, holding means of holding the angle of aperture formed between the first housing 1310 and second housing 1320 at a specific angle by an energizing force using a spring is set in the hinge brackets 1313a and 1313b and the hinge arm 1323 and the specific angle is applied to the collapsed state shown in FIG. 13(a) and the operating state shown in FIG. 12 (a). Furthermore, the entire disclosure of Japan Patent No. 2821333 are incorporated herein by reference in its entirety.

The above two folding mobile telephone is further decreased in thickness and size in order to further improve its portability.

However, the above two folding mobile telephone has the following problems.

When operating a mobile telephone, a user talks by bringing the mobile telephone nearby his head so that the voice output plane comes nearby his ear and the voice input plane nearby this mouth. FIG. 14(a) is an illustration schematically showing a positional relation between each portion of a mobile telephone when operated and the head of a user.

As shown in FIG. 14(a), when bringing the two folding mobile telephone 1300 nearby a head 1400, various portions formed on the first housing 1310 and second housing 1320 also approach the head 1400. Among these portions, a position of front ends of the grounding plate 1315 and helical antenna 1314 and the head 1400 greatly influence the gain of a two folding mobile telephone.

In FIG. 14(a), distance A shows the distance from the front end of the helical antenna 1314 up to the head 1400, distance B shows the distance from the grounding plate 1315 in the first housing up to the surface of the head 1400, and distance C shows the average thickness of the second housing, and distance D shows the average thickness of the first housing. The angle of aperture formed between the first housing 1310 and the second housing 1320 is equal to 165° in the case of conventional examples 1 and 2. Therefore, the angle of depression “a” of the first housing 1310 to the second housing 1320 becomes 15° as shown in figure. Moreover, the arrow extending from the voice output plane 1322 shows the direction in which the directivity of an audio signal output from the voice output plane 1322 is maximized.

FIG. 14(b) shows a relation between the thickness of the housing of a two folding mobile telephone, the distance between the phase center Cₚ between the grounding plate 1315 and the helical antenna 1314 minimized in length, and the head 1400 on one hand and a gain loss on the other in the form of a table.

In the case of the conventional example 2, thicknesses of the first housing 1310 and second housing 1320 are smaller than the case of the conventional example 1. Moreover, the distance A from the front end of the helical antenna 1314 up to the surface of the head 1400 and the distance B from the grounding plate 1315 up to the surface of the head 1400 in the case of the conventional example 2 are smaller than the case of the conventional example 1. That is, front ends of the grounding plate and antenna built in a housing in the case of the conventional example 2 having a housing thinner than that of the conventional example 1 are closer to a head compared to the case of the conventional example 1.

In this case, a mobile telephone has a problem that when an antenna approaches a human body, the gain loss for transmission or reception increases.

In the case of the example shown in FIG. 14(b), the conventional example 2 produces the total gain loss of approx. −2.0 dB including the gain loss α caused by the helical antenna 1314 and the gain loss β caused by the grounding plate 1315 on the basis of the conventional example 1. That is, decrease of a housing in thickness causes reception gain to decrease.

### SUMMARY OF THE INVENTION

The present invention is made to solve the above problems and its object is to provide a two folding mobile telephone capable of reducing the attenuation of gain for reception even if a housing is decreased in size and thickness.

The 1^{st} aspect of the present invention is a two folding mobile telephone comprising:

a first housing having an antenna, a built-in grounding plate, and a hinge bracket set to an inside principal plane of said first housing;

a second housing having a hinge arm corresponding to said hinge bracket, which is set over at least an end portion, a display screen set to an inside principal plane to display information, and a voice output plane of a loudspeaker opposite to said hinge arm at the both sides of said display screen; and

a fixing mechanism of temporarily fixing said hinge bracket and said hinge arm; wherein,

said first housing and said second housing are connected so that their inside principal planes face each other when closed,

an angle of aperture formed between the inside of a virtual plane orthogonal to the direction when the directivity of an audio signal of said loudspeaker is maximized and the inside of a plane including said grounding plate is held at substantially 165° or larger by temporary fixing by said fixing mechanism, and

said virtual plane is substantially the same as or parallel with a plane including the voice output plane of said loudspeaker and said display screen for displaying information.

The 2^{nd} aspect of the present invention is the two folding mobile telephone according to the 1^{st} aspect, where in,

said fixing mechanism has a stopper set to said first housing and/or said second housing and elastic holding means of holding so that said angle of aperture is held constant by an elastic force,

said elastic holding means provides an energizing force for said angle of aperture to tend to a predetermined first angle,

said stopper is set so that said angle of aperture becomes a second angle smaller than said first angle, and

said second angle is an angle equal to or smaller than a first limit angle at which an allowance accompanying holding by the energizing force of said elastic holding means cannot be permitted.

The 3^{rd} aspect of the present invention is the two folding mobile telephone according to the 1^{st} aspect, wherein,

said fixing mechanism has elastic holding means for holding so that said angle of aperture is kept constant by an elastic force, and

said angle of aperture is equal to or smaller than a second limit angle at which said angle of aperture can be held by said elastic holding means.

The 4^{th} aspect of the present invention is the two folding mobile telephone according to the 1^{st} aspect, wherein,

said angle of aperture kept by said temporary fixing substantially 166° or larger and 172° or smaller at which said angle of aperture can be held by said temporary fixing.

The 5^{th} aspect of the present invention is the two folding mobile telephone according to the 1^{st} aspect, wherein,

the inside principal plane of said first housing and the inside principal plane of said second housing have a step when the inside principal plane of said first housing and the inside principal plane of said second housing open so that the angle formed between the inside principal planes of them becomes substantially 180°, and

the inside principal plane of said first housing retreats toward the inside of the housing from the inside principal plane of said second housing.

The 6^{th} aspect of the present invention is the two folding mobile telephone according to the 1^{st} aspect, wherein,

the average distance between the inside principal plane of said first housing and the outside principal plane opposite to the inside principal plane of said first housing is equal to substantially 7 mm and the average distance between the inside principal plane of said second housing and the outside principal plane opposite to the inside principal plane of said second housing is equal to substantially 9.8 mm.

The 7^{th} aspect of the present invention is a two folding mobile telephone comprising:

a first housing having an antenna, a built-in grounding plate, and a hinge bracket set to the inside principal plane of said first housing;

a second housing having a hinge arm corresponding to said hinge bracket, which is provided over at least an end portion, a display screen set to an inside principal plane to display information, and a voice output plane of a loudspeaker opposite to the hinge arm at the both sides of said display screen; and

a fixing mechanism of temporarily fixing said hinge bracket and said hinge arm; wherein,

said first housing and said second housing are connected so that their inside principal planes face each other when closed,

a virtual plane orthogonal to a direction when the directivity of an audio signal of said loudspeaker is maximized tilts from a plane including said display screen, and

a direction of said tilt is in a direction in which the direction when the directivity of the audio signal of said loudspeaker is maximized and said display screen form an obtuse angle.

The 8^{th} aspect of the present invention is a mobile telephone comprising:

a housing having an antenna, a built-in grounding plate, a display screen set to an inside principal plane to display information, and the voice output plane of a loudspeaker, wherein,

a virtual plane orthogonal to a direction in which the directivity of an audio signal of said loudspeaker is maximized tilts from a plane including said display screen, and

a direction of tilt is in a direction in which a direction when the directivity of the audio signal of said loudspeaker is maximized and said display screen form an obtuse angle.

The 9^{th} aspect of the present invention is the two folding mobile telephone according to the 7^{th} aspect, wherein,

said virtual plane is formed as said voice output plane on the inside principal plane of said first housing.

The 10^{th} aspect of the present invention is a two folding mobile telephone comprising:

a first housing having a built-in grounding plate and a hinge bracket set on an inside principal plane of said first housing;

a second housing having a hinge arm corresponding to said hinge bracket, provided over at least an end portion, a display screen set to an inside principal plane to display information, a voice output plane of a loudspeaker opposite to said hinge arm at the both sides of said display screen, an antenna; and

a fixing mechanism of temporarily fixing said hinge bracket and said hinge arm; wherein,

said first housing and said second housing are connected so that the housings are faced each other and closed,

an angle of aperture formed between the inside of a virtual plane orthogonal to a direction in which the directivity of the audio signal of said loudspeaker is maximized and the inside of the plane including said grounding plate is held at substantially 165° or larger by temporary fixing by said fixing mechanism, and

said virtual plane is substantially the same as or parallel with a plane including the voice output plane of said loudspeaker and the display screen for displaying information.

The 11^{th} aspect of the present invention is a two folding mobile telephone comprising:

a first housing having a hinge bracket set to an inside principal plane of said first housing and an antenna;

a second housing having a hinge arm corresponding to said hinge bracket, which is set over at least an end portion, a display screen set to an inside principal plane to display information, a voice output plane of a loudspeaker opposite to said hinge arm at the both sides of said display screen, and a built-in grounding plate; and

a fixing mechanism of temporarily fixing said hinge bracket and said hinge arm; whrein,

said first housing and said second housing are connected so that the inside principal planes of said housings are faced each other and closed,

an angle of aperture formed between the inside of a virtual plane orthogonal to a direction in which the directivity of the audio signal of said loudspeaker is maximized and the inside of a plane including said grounding plate is held at substantially 165° or larger by temporary fixing by said fixing mechanism, and

said virtual plane is substantially the same as or parallel with a plane including the voice output plane of said loudspeaker and said display screen for displaying information.

### BRIEF DESCRIPTION OF THE DRAWINGS

FIG. 1(a) is a block diagram of the two folding mobile telephone of the embodiment 1 of the present invention;

FIG. 1(b) is a block diagram of the two folding mobile telephone of the embodiment 1 of the present invention;

FIG. 1(c) is a block diagram of the two folding mobile telephone of the embodiment 1 of the present invention;

FIG. 2(a) is a block diagram of the two folding mobile telephone of the embodiment 1 of the present invention;

FIG. 2(b) is a block diagram of the two folding mobile telephone of the embodiment 1 of the present invention;

FIG. 2(c) is a block diagram of the two folding mobile telephone of the embodiment 1 of the present invention;

FIG. 3(a) is an illustration schematically showing a positional relation between each section of the two folding mobile telephone of the embodiment 1 of the present invention when operated and the head of a user;

FIG. 3(b) is an illustration showing a table of comparison between gain losses of the two folding mobile telephone of the embodiment 1 of the present invention and a conventional example;

FIG. 4(a) is an illustration schematically showing a configuration of elastic holding means of the two folding mobile telephone of the embodiment 1 of the present invention;

FIG. 4(b) is an illustration schematically showing a configuration of elastic holding means of the two folding mobile telephone of the embodiment 1 of the present invention;

FIG. 4(c) is an illustration schematically showing a configuration of elastic holding means of the two folding mobile telephone of the embodiment 1 of the present invention;

FIG. 4(d) is an illustration schematically showing a configuration of elastic holding means of the two folding mobile telephone of the embodiment 1 of the present invention;

FIG. 5 is an illustration for explaining operations of the elastic holding means of the two folding mobile telephone of the embodiment 1 of the present invention;

FIG. 6(a) is an illustration showing an angle of aperture between housings of the two folding mobile telephone of the embodiment 1 of the present invention;

FIG. 6(b) is an illustration showing an angle of aperture between housings of a conventional two folding mobile telephone;

FIG. 7(a) is a block diagram of the two folding mobile telephone of the embodiment 2 of the present invention;

FIG. 7(b) is a block diagram of the two folding mobile telephone of the embodiment 2 of the present invention;

FIG. 7(c) is a block diagram of the two folding mobile telephone of the embodiment 2 of the present invention;

FIG. 8 is an illustration schematically showing a positional relation between each section of the two folding mobile telephone of the embodiment 2 of the present invention when operated and the head of a user;

FIG. 9(a) is an illustration showing another configuration of the two folding mobile telephone of the embodiment 2 of the present invention;

FIG. 9(b) is an illustration showing another configuration of the two folding mobile telephone of the embodiment 2 of the present invention;

FIG. 9(c) is an illustration showing another configuration of the two folding mobile telephone of the embodiment 2 of the present invention;

FIG. 10(a) is an illustration showing another configuration of the two folding mobile telephone of the embodiment 1 of the present invention;

FIG. 10(b) is an illustration showing another configuration of the two folding mobile telephone of the embodiment 1 of the present invention;

FIG. 10(c) is an illustration showing another configuration of the two folding mobile telephone of the embodiment 1 of the present invention;

FIG. 11(a) is an illustration schematically showing a positional relation between each section of the two folding mobile telephone of the embodiment 1 of the present invention when operated and the head of a user;

FIG. 11(b) is an illustration showing a table of comparison between gain losses of the two folding mobile telephone of the embodiment 1 of the present invention and a conventional example;

FIG. 12(a) is a block diagram of a two folding mobile telephone of the prior art;

FIG. 12(b) is a block diagram of a two folding mobile telephone of the prior art;

FIG. 12(c) is a block diagram of a two folding mobile telephone of the prior art;

FIG. 13(a) is a block diagram of a two folding mobile telephone of the prior art;

FIG. 13(b) is a block diagram of a two folding mobile telephone of the prior art;

FIG. 14(a) is an illustration schematically showing a positional relation between each section of a two folding mobile telephone of the prior art when operated and the head of a user;

FIG. 14(b) is a table of comparison between gain losses of a two folding mobile telephone of the prior art;

FIG. 15 is an illustration showing a graph showing a relation between the angle of aperture between the first housing and second housing and the antenna gain of the two folding mobile telephone of the embodiment 1 of the present invention;

FIG. 16 is a block diagram of a mobile telephone of the second embodiment of the present invention;

FIG. 17 is an illustration showing a configuration of a loop antenna of an embodiment of the present invention;

FIG. 18 is an illustration showing another configuration of the present invention; and

FIG. 19 is an illustration showing another configuration of the present invention.

### DESCRIPTION OF SYMBOLS

100 Two folding mobile telephone

110 First housing

111 Input section

112 Voice input plane

113a, 113b Hinge bracket

114 Helical antenna

115 Grounding plate

116 Stopper

120 Second housing

121 Display screen

122 Voice output plane

### PREFERRED EMBODIMENTS OF THE INVENTION

Embodiments of the present invention are described below by referring to the accompanying drawings.

(Embodiment 1)

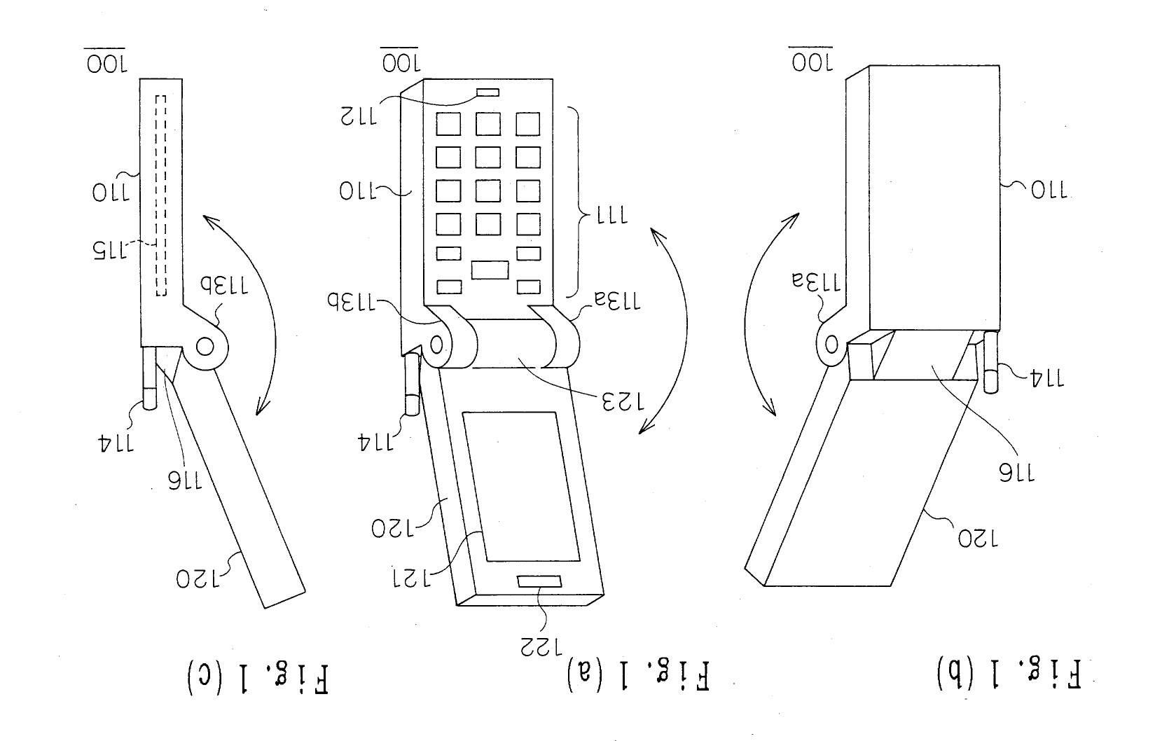

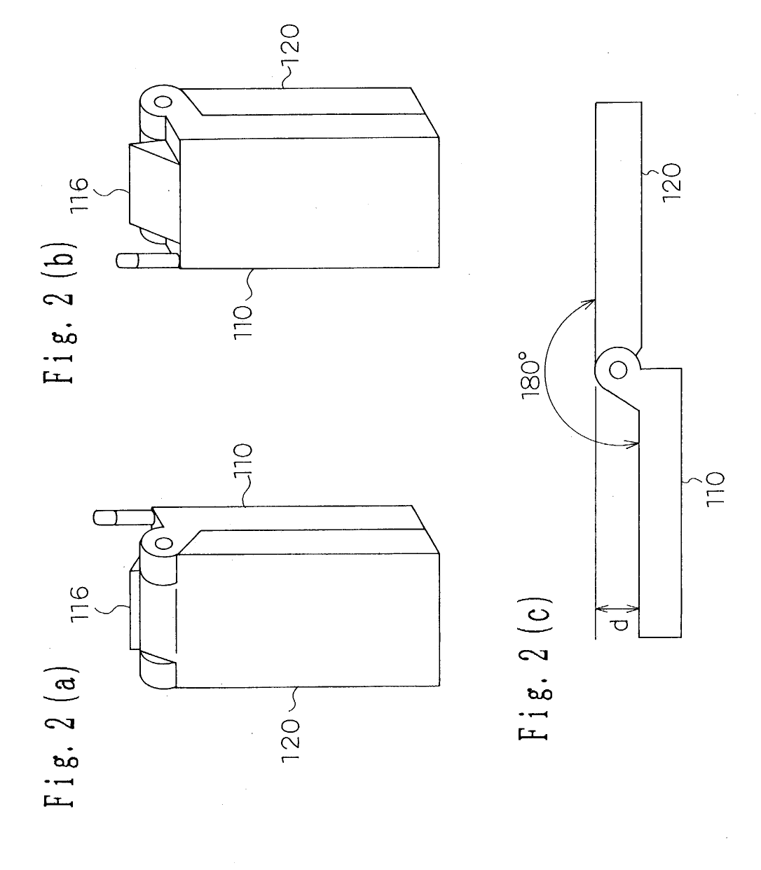

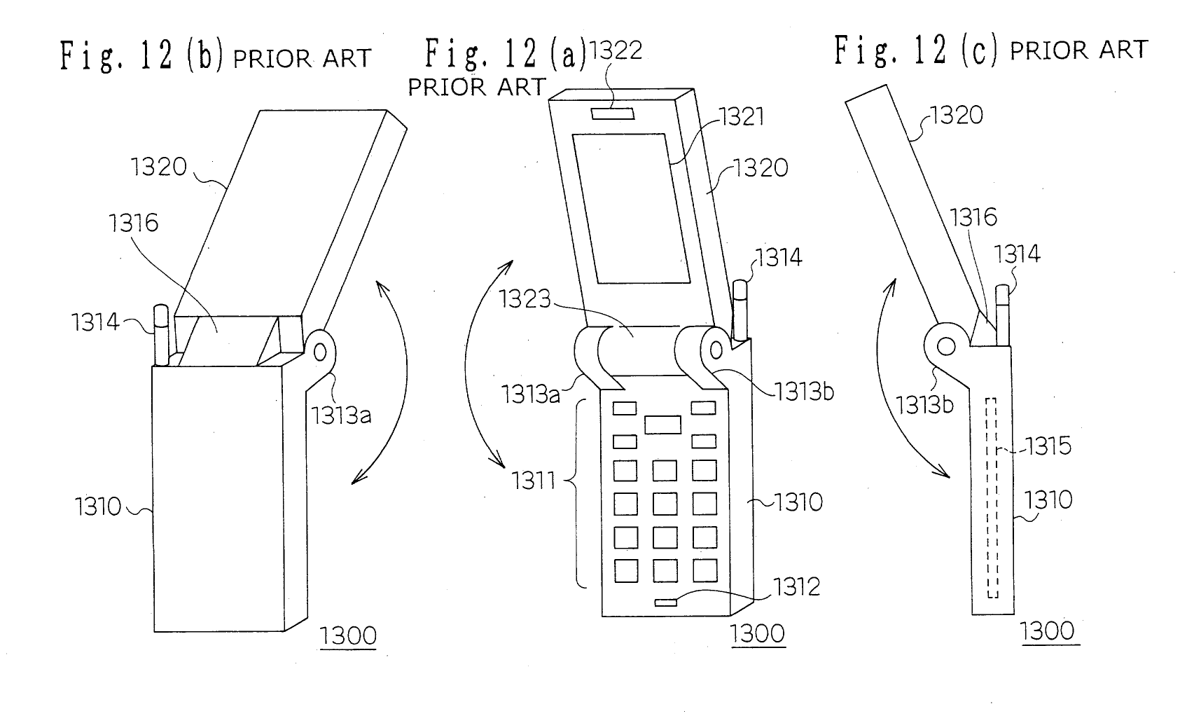

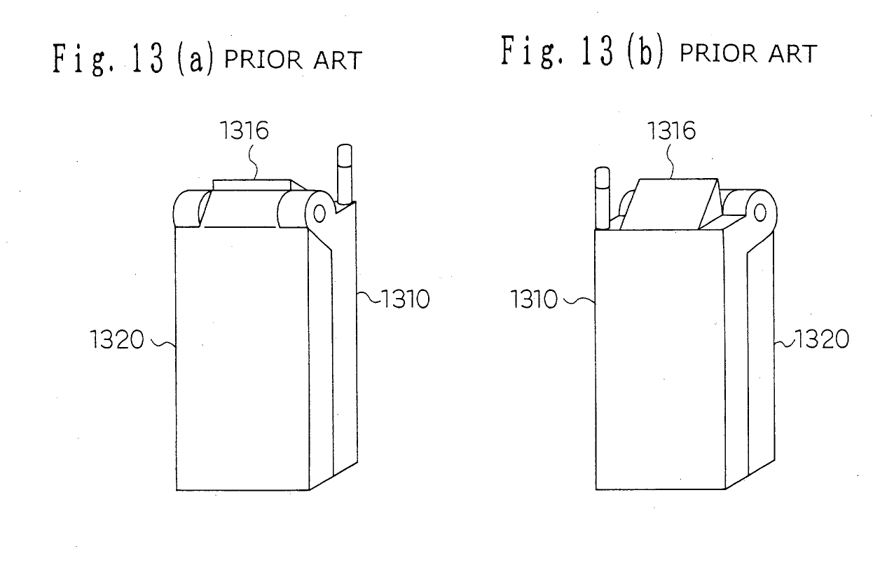

FIGS. 1(a) to 1(c) and FIGS. 2(a) and 2(b) are block diagrams of a two folding mobile telephone of an embodiment 1 of the present invention. As shown in FIGS. 1 and 2, the configuration of a two folding mobile telephone 100 is basically the same as that of the conventional example shown in FIGS. 12 and 13 and the two folding mobile telephone 100 has a first housing 110 with an input section including a ten-key pad set on its inside principal plane and a second housing 120 with a display screen 121 set on its inside principal plane.

A voice input plane 112 with a microphone for inputting voices set on it is formed on the inside principal plane of the first housing 110 in addition to an input section 111 and moreover, hinge brackets 113a and 113b to be rotatably connected with the second housing are set to positions opposite to the voice input plane 112 at the both sides of the input section 111 on the inside principal plane. Moreover, a retractable helical antenna 114 is set nearby the outside principal plane of the first housing and an grounding plate 115 for earthing various sections of internal circuits of a mobile telephone is built in the first housing. The position to which the earthing bottom bard 1145 is set is a position at which the thickness of the first housing is substantially halved.

Moreover, a voice output plane 122 with a loudspeaker set on it for outputting voices is formed on the inside principal plane of the second housing 120 in addition to the display screen 121 and a hinge arm 123 to be rotatably connected with the first housing is set to the position opposite to the voice output plane 122 at the both sides of the display screen 121 at an end portion of the second housing.

As shown in FIGS. 12 and 13, the first housing 110 and second housing 120 are connected each other because the hinge arm 123 is fitted between the hinge brackets 113a and 113b and rotatably movable in directions of the arrows in FIGS. 12 and 13. Though the hinge brackets 113a and 113b are set to the both ends of the hinge arm 123, it is also allowed to divide the hinge arm 123 into two parts or more and set the hinge brackets 113a and 113b between the divided hinge arms. However, from the viewpoint of the strength of a hinge for holding an angle of aperture, it is preferable to use the illustrated structure.

In this case, the first housing 110 with the hinge arm set on it rotates up to a predetermined angle, it is stopped by a stopper 116 set to an end of the first housing 110. Moreover, as shown in FIG. 2(c) , when assuming that the stopper 116 is omitted and setting the angle of aperture formed between the first housing 110 and second housing to 180°, a configuration is realized in which the inside principal plane of the first housing 110 and that of the second housing 120 have a step d and the inside principal plane of the first housing retreats to the inward of the housing compared to the inside principal plane of the second housing 120 by the step d.

When the two folding mobile telephone 100 is not operated, it is possible to collapse the two folding mobile telephone 100 so that the inside principal planes of the both housings are faced each other as shown in FIG. 2 (a) and (b), improve the portability, and secure a large display screen using the most part of the inside principal plane of the second housing.

The two folding mobile telephone of this embodiment having the above configuration is characterized in that the angle of aperture formed between the first housing 110 and second housing 120 is made larger than the case of a conventional example. The effect of the large angle of aperture is described below.

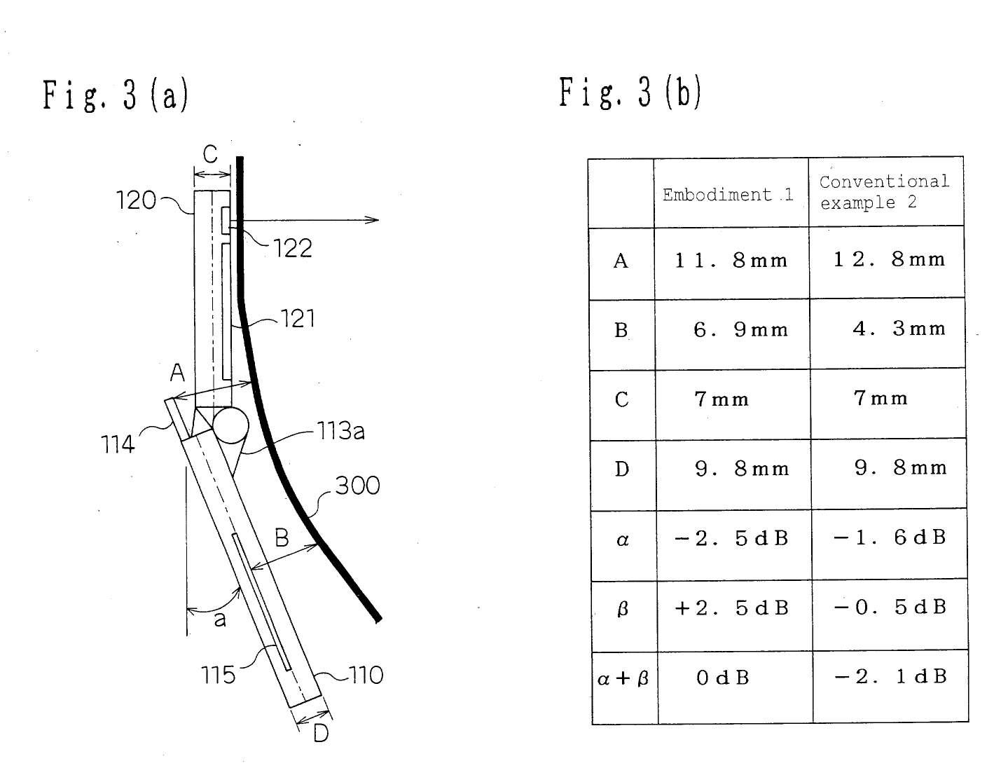

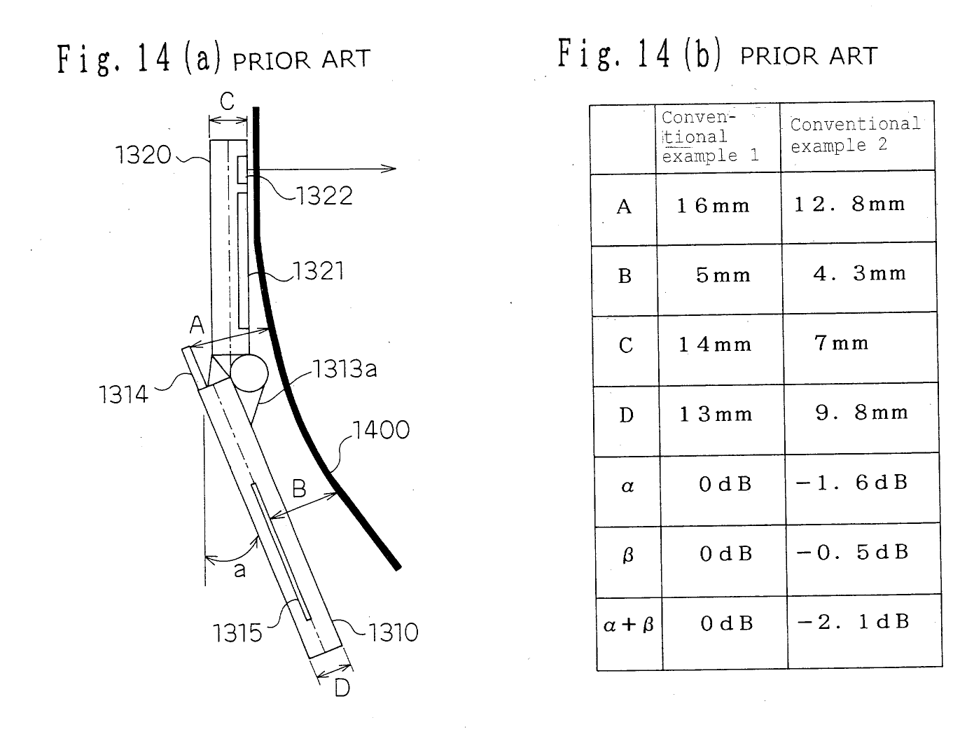

FIG. 3(a) is an illustration schematically showing a positional relation between each section of a two folding mobile telephone when operated and the head of a user. Because the correspondence of symbols showing distances and dimensions is the same as the case of the conventional example shown in FIG. 14 (a) , detailed description is omitted. However, the angle of aperture formed between the first housing 110 and second housing shown in FIG. 3 (a) is equal to 168° in the case of this embodiment and therefore, the angle of depression “a” of the first housing 110 to the second housing 120 becomes 12°.

FIG. 3(b) shows a relation between the thickness of the housing of a two folding mobile telephone, distances between the grounding plate 115, the front end of the helical antenna 114 minimized in length, and the head 300 on one hand and a gain loss on the other as a comparison table between this embodiment and the conventional example in FIG. 14(b).

As shown in the table, because the embodiment 1 and the conventional example 2 have housings of the same dimensions, the distance C and distance D are equal to each other. However, because the angle of aperture between the first housing 110 and second housing 120 of this embodiment is larger than the case of the conventional example 2 by 3°, the distance A becomes smaller than the case of the conventional example 2 but the distance B becomes larger than the case of the conventional example 2.

Therefore, as shown in the table, the gain loss α due to the distance A from the front end of the helical antenna 114 up to the surface of the head 300 slightly increases. However, the reduction of the gain loss β due to the distance B from the grounding plate 115 up to the surface of the head 300 increases and the increase of the gain loss β is sufficiently compensated. Therefore, the gain loss is decreased as a whole.

However, when further increasing the angle of aperture between the first housing 110 and the second housing, the distance A decreases and the gain loss α due to the distance A further increases. However, because the reduction amount of the gain loss α due to the increase of the distance B approaches a saturated state, the gain loss increases as a whole. Therefore, it is preferable to realize an angle of aperture so that the relation between the distances A and B is optimized.

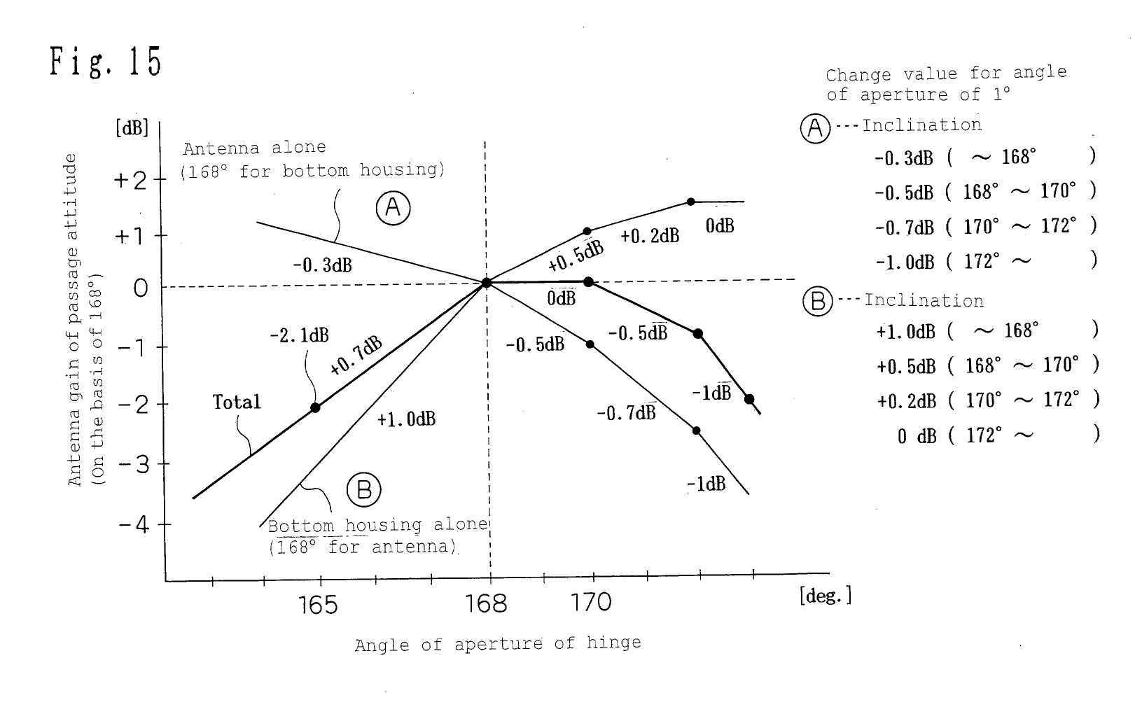

FIG. 15 shows a relation between the angle of aperture between the first housing 110 and second housing 120 and influences of the helical antenna 114 and grounding plate 115 on a reception gain in the form of a graph in detail. As shown by the broken line A in FIG. 15, when the angle of aperture between the first housing 110 and second housing 120 increases, an single antenna moves only in the direction of approaching the head 300 and thereby, the gain of the antenna reduces. The inclination of the reduction increases as an angle of aperture increases, for example, by −0.3 dB for 1° when an angle of aperture is smaller than substantially 168°, −0.5 dB for 1° when an angle of aperture ranges substantially between 168° and 170°, −0.7 dB for 1° when an angle of aperture ranges between 170° and 172°, and −1.0 dB for 1° when an angle of aperture is larger than 172°.

However, as shown by the broken line B, when an angle of aperture is approx. 165° the same as the case of a conventional example, the gain of an antenna increases as an angle increases and the grounding plate 115 provides an inclination of monotone increase (+1.0 dB for 1°) until the angle of aperture becomes 168°. Moreover, an increasing trend is maintained substantially up to 168° to 170° but the inclination is moderated (+0.5 dB for 1°) and further moderated in the range of substantially 170° to 172° (+0.2 dB for 1°) to increase an antenna gain, and a saturated state is realized (inclination of 0) when the angle of aperture becomes 172° or more.

As described above, by making the angle of aperture between the first housing 110 and second housing 120 larger than 165° which is conventionally known, the attenuation of a gain due to the fact that an antenna approaches the head 300 is compensated by the increase of a gain due to the fact that the grounding plate 115 is spaced away from the head 300. Therefore, it is found that the total gain is monotone-increased up to an angle of aperture of substantially 168°. Moreover, it is possible to keep the peak up to at least 170°.

Therefore, by setting the angle of aperture between the first housing 110 and second housing 120 to a value larger than the case of a conventional example and ideally setting a range of 168° substantially to 170° or substantially setting a range of at least 166° to 172° as an optimum angle, it is possible to sufficiently increase an antenna gain.

Then, a mechanism for keeping the angle of aperture between the first housing 110 and second housing 120 at a value larger than the case of a conventional example is described below.

This embodiment also includes elastic holding means of holding the angle of aperture between the first housing 110 and second housing 120 at a specific angle in a collapsed state or operating state by an energizing force using a spring or the like in the hinge brackets 113a and 113b and the hinge arm 123 the same as the case of a conventional example.

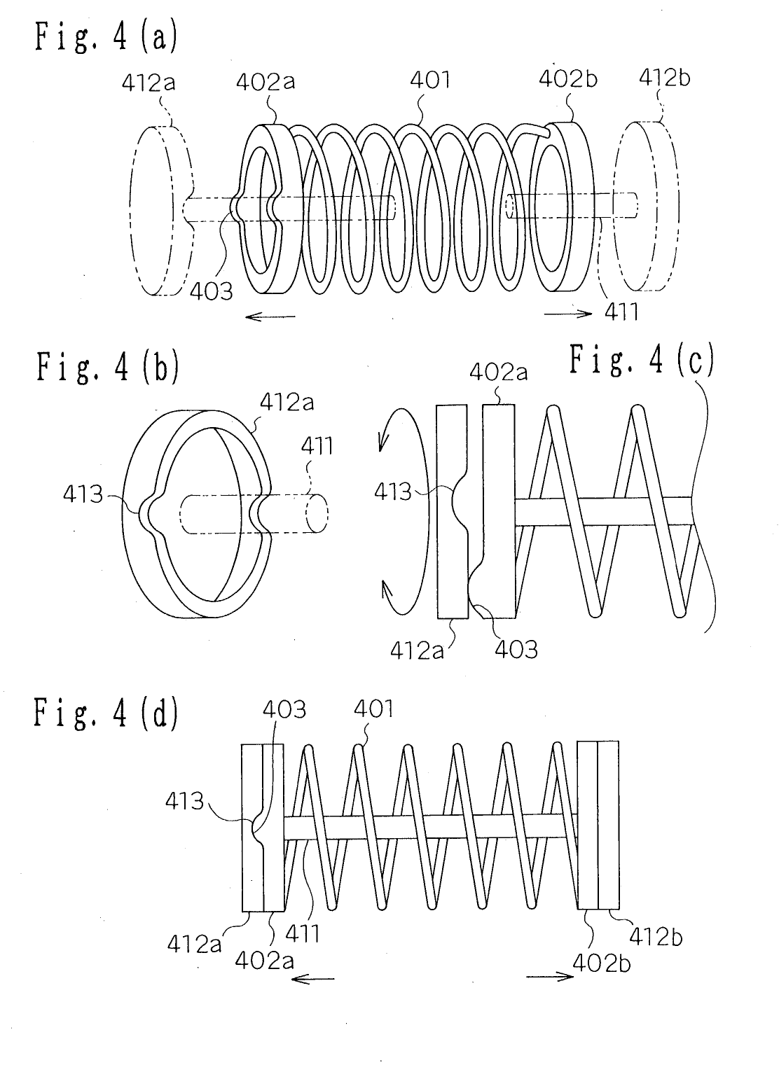

FIG. 4(a) schematically shows a configuration of elastic holding means. The elastic holding means is constituted by a spring portion fixed in the hinge bracket 113a or 113b and a support portion fixed in the hinge arm 123. The spring portion has a hollow helical spring 401 with a predetermined length and hollow sliding members 402a and 402b connected to the both ends of the helical spring 401 and a support body 411 of the support portion is built in the hollow portion. In FIG. 4 (a), the support body 411 is schematically locally cut off so that description is understandable.

The support portion has the support body 411 in which the spring portion is set and end members 412a and 412b set to the both ends of the support body 411. Because an elastic force works on the helical spring 401 in the direction in which the length increases, an energizing force is applied to the sliding members 402a and 402b in the direction in which the members are separate from each other (arrows in FIG. 4(a)) and thereby the end member 412a contacts with the sliding member 402a and the end member 412b contacts with the sliding member 402b. Therefore, by opening or closing the first housing 110 and second housing 120 of the two folding mobile telephone 100, the spring portion fixed to the first housing 110 rotates around the shaft of the support body 411.

Moreover, in the case of the sliding member 402a and end member 412a, predetermined concave and convex shapes corresponding to each other are formed on face opposite to each other. FIG. 4 (a) shows the shape of the sliding member 402a and FIG. 4(b) shows the shape of the end member 412a. The sliding member 402a has a convex portion 403 on its principal plane and the end member 412a has a concave portion 413 corresponding to the convex portion 403 on its principal plane.

As shown in FIG. 4(c), when the first housing 110 and the second housing 120 are opened or closed, the sliding member 402a rotates around the main-shaft body 411 while the convex portion 403 contacts with the principal plane of the end member 412a. When the end member 412a rotates up to a certain extent, the convex portion 403 and concave portion 413 are faced each other, the convex portion 403 is fitted into the concave portion 413 by the energizing force of the helical spring 401 as shown in FIG. 4(d), and the spring portion and support portion are fixed to each other. The vicinity of the fixing position serves as the angle of aperture between the first housing 110 and second housing 120 (corresponding to a predetermined first angle of the present invention). However, because accuracies of the convex portion 403 and concave portion 413 are not very strict but the so-called allowance is provided for them, a tolerance is produced in an angle of aperture even if the convex portion 403 is fitted into the concave portion 423.

This represents that it is impossible to temporarily fix the angle of aperture between the first housing 110 and second housing 120 by only the holding force of the elastic holding means. Therefore, the angle of aperture is temporarily fixed by the energizing force of the elastic holding means and the drag from the stopper 116 by using the stopper 116 of the first housing 110.

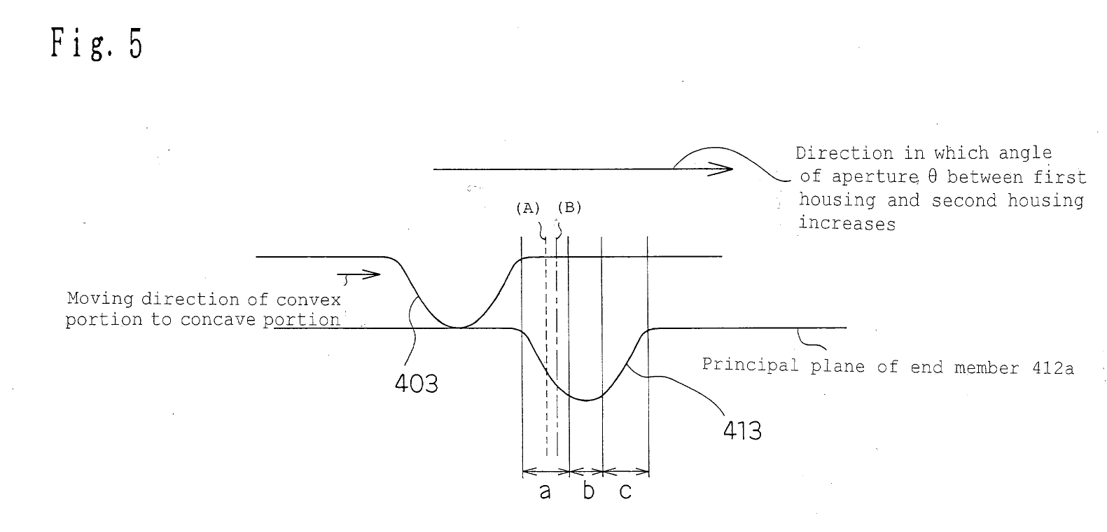

FIG. 5 is an illustration for explaining a condition for temporarily fixing the angle of aperture between the first housing 110 and second housing 120 of the two folding mobile telephone 100.

As shown in FIG. 5, when spreading the first housing 110 and second housing 120, the convex portion 403 of the sliding member 402a of the spring portion moves on the principal plane of the end member 412a in the direction of being fitted into the concave portion 413 and a force is applied in the direction of being further fitted into the concave potion 413 by the energizing force from the helical spring 401. Therefore, when the convex portion 403 is present in an area “a” which is a slope on the concave portion 413, a force is applied to the convex portion 403 in the direction in which the angle of aperture θ between the first housing 110 and second housing 120 increases. Moreover, when the convex portion 403 is present in an area “b” which is the bottom of the concave portion 413, a force is applied in the direction of being fixed to the concave portion 413. Furthermore, when the convex portion 403 is present in an area “c” which is the slope of the concave portion 413, a force is applied in the direction in which the angle of aperture θ between the first housing 110 and second housing 120 decreases.

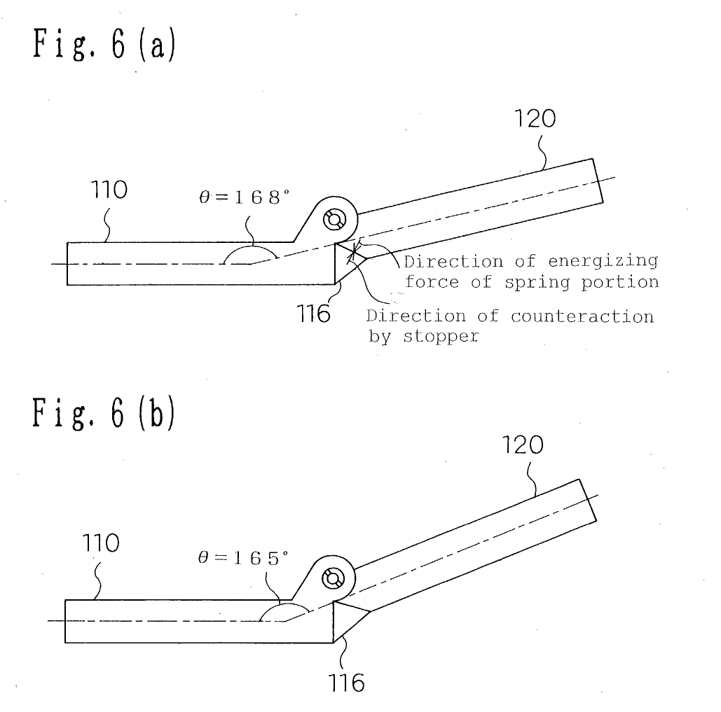

In this case, as shown in FIG. 6(a), the first housing 110 is stably fixed by the energizing force of the spring portion and the drag as a counteraction of the energizing force received from the stopper 116 by setting the stopper 116 so as to correspond to a first limit angle obtained by assuming the angle of aperture between the first housing 110 and second housing 120 when the convex portion 403 is present in the area “a” as the fist limit angle, that is, as an angle at which the allowance due to holding by the energizing force of the elastic holding means cannot be allowed.

As shown in FIG. 5, the area “a” where an energizing force works in the direction in which the angle of aperture θ between the first housing 110 and second housing 120 increases has a predetermined width. In the case of a conventional example, however, the stopper 116 is set so as to be θ=165° as shown (A) in FIG. 5 because of a human-engineering reason.

In the case of this embodiment, however, the stopper 116 is set to a potion at which θ decided as the first limit angle further increases in order to obtain optimum conditions of the antenna and grounding plate shown in FIG. 15 by separating the grounding plate 115 built in the first housing 110 from the head of a user and θ is set to, for example, 168° as shown (B) in FIG. 5 to obtain the results shown in FIG. 3.

Though it is possible to increase the angle of aperture θ as long as the position of the convex portion 403 is mechanically present in the area “a” in FIG. 5, it is impossible to exceed the second limit angle at which holding can be made by the elastic holding means. Therefore, it is most preferable to set 170° which is a limit angle of aperture for proving an optimum antenna gain or an angle of approx. 172° when considering a tolerance to θ as the above second limit angle.

Moreover, when setting θ to such an extremely large value as the phase center Cₚ of the helical antenna 114 comes above the rotational center of a hinge, the phase center Cₚ approaches the display screen 121 and the radiation from the antenna may adversely affect screen display.

Moreover, particularly when θ exceeds substantially 180°, a two folding mobile telephone bends backward as a whole and thereby, a trouble occurs that the two folding mobile telephone cannot be easily handled. Therefore, it is not preferable to set θ to an angle larger than substantially 180°.

In the above description, the angle of aperture θ corresponds to an angle of aperture formed between the inside of a virtual plane orthogonal to a direction in which the directivity of an audio signal of a loudspeaker of the present invention is maximized and the inside of a plane including an grounding plate.

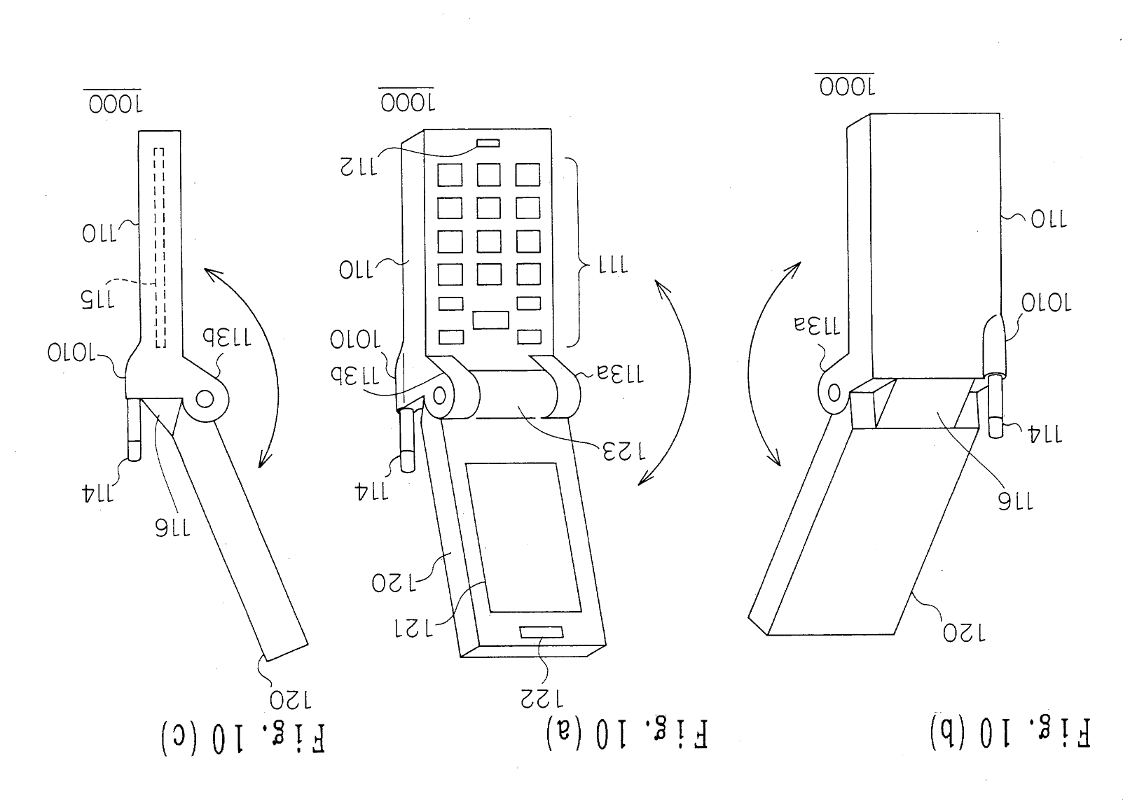

Moreover, it is allowed to form this embodiment so as to have the constitution shown in FIGS. 10(a) to 10(c).

FIGS. 10(a) to 10(c) are block diagrams of another example of the two folding mobile telephone of the embodiment 1. As shown in FIGS. 10(a) to 10(c), for the constitution of the two folding mobile telephone 1000, a portion same as or corresponding to that in FIG. 1 is provided with the same symbol and its detailed description is omitted. Moreover, a raised portion 1010 formed because a part of the helical antenna 114 is slightly raised is present on the outside principal plane located at the opposite side of the inside principal plane of the first housing 110 to the grounding plate 115. The raised portion 1010 is formed by setting the helical antenna 114 to a position nearby the outside principal plane compared to the case of a conventional example.

The two folding mobile telephone having the above configuration is different in that the helical antenna 114 is set more nearby the outside principal plane by a value equivalent to the raised portion 1010 though the angle of aperture between the first housing 110 and second housing 120 is the same as the case of the configuration shown in FIG. 1.

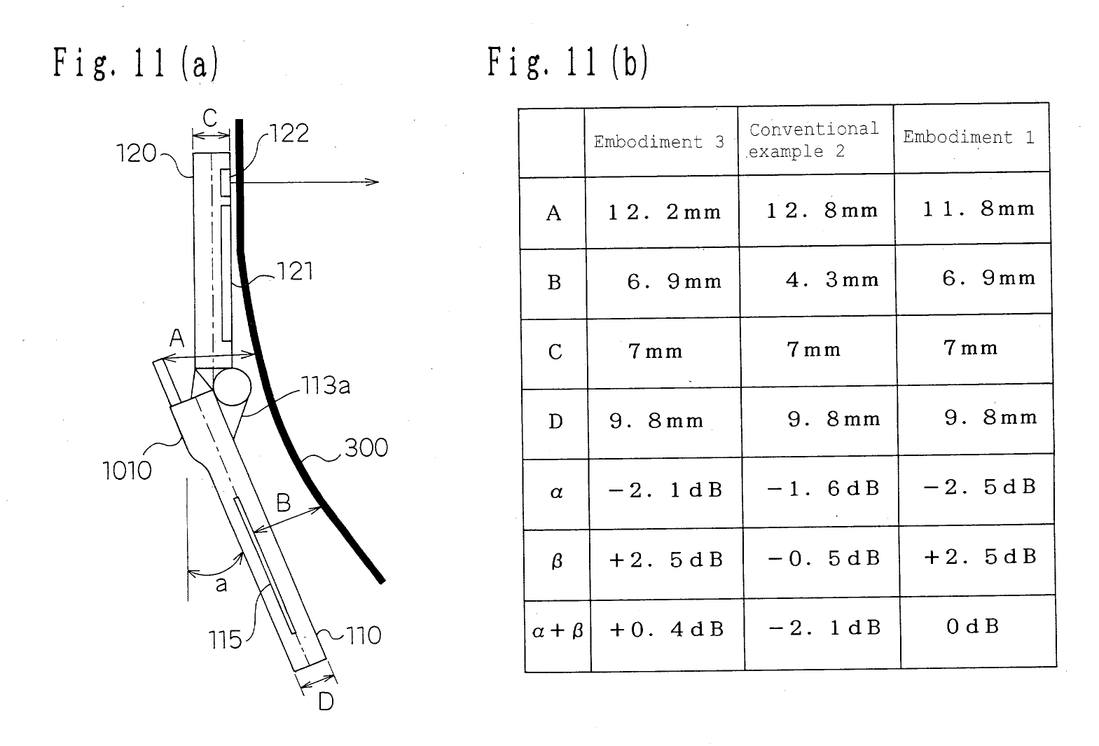

FIG. 11(a) is an illustration schematically showing a positional relation between each section of the two folding mobile telephone of this embodiment when operated in another configuration and the head of a user. Because the correspondence of each symbol showing a distance or dimension is the same as the case of the conventional example shown in FIG. 14(a) , detailed description of the symbol is omitted. Moreover, the angle of aperture formed between the first housing 110 and second housing 120 is substantially 168° and the angle of depression of the first housing 110 to the second housing 120 shown in FIG. 11(a) is substantially 12°.

FIG. 11(b) shows relations between the thickness of the housing of a two folding mobile telephone, the distance between the grounding plate 115 the front end of the helical antenna 114 and the head 300, and a gain loss as a table of comparison between the configuration in FIG. 1 and the conventional example 2 in FIG. 14(b).

As shown in the table, because this embodiment and the conventional example 2 respectively have a housing of substantially the same dimension, the distance C and distance D are equal to each other. However, the angle of aperture formed between the first housing 110 and second housing is 168° which is the same as the case of the embodiment 1 and the distance A between the front end of the helical antenna 114 and the head 300 becomes larger than the cases of the conventional example 2 and the embodiment 1 because the raised portion 1010 is formed as shown in FIG. 11 (a). The table shows an example in which the distance A is set to a value 0.4 mm larger than the case of the embodiment 1.

Therefore, it is possible to further reduce the gain loss α due to the distance A from the helical antenna 114 up to the surface of the head 300 compared to the case of the embodiment 1 and reduce the whole gain loss.

Also in the case of a conventional example, it is known that the distance between an antenna and the body of a user is maximized by, for example, setting the antenna so that it greatly rises from the surface of a housing including the antenna.

However, when setting the antenna so that it greatly rises from the surface of the housing in order to reduce the gain loss due to decrease of the housing in thickness and mounting the housing on the ground or a table, the housing may be mounted in an unstable state due to a part of the housing and the antenna or a user may feel uncomfortable when grasping the housing by his hand.

Therefore, it is more preferable to minimize the height of the raised portion 1010 from the outside principal plane of the portion 1010 because the portion 1010 does not interrupt taking-in/out when housed or does not make a user feel uncomfortable.

Thus, according to this embodiment, because the angle of aperture between housings is increased than ever, it is possible to obtain an optimum condition for reducing an antenna gain loss due to decrease of a mobile telephone in thickness by keeping an grounding plate from a head while making an antenna approach a human body.

A setting position of the antenna 114 is not restricted to the position shown in FIG. 1. It is allowed to set the antenna to any position as long as the position becomes more distant from a human body when increasing the angle of aperture between the housing 110 and second housing 120.

(Embodiment 2)

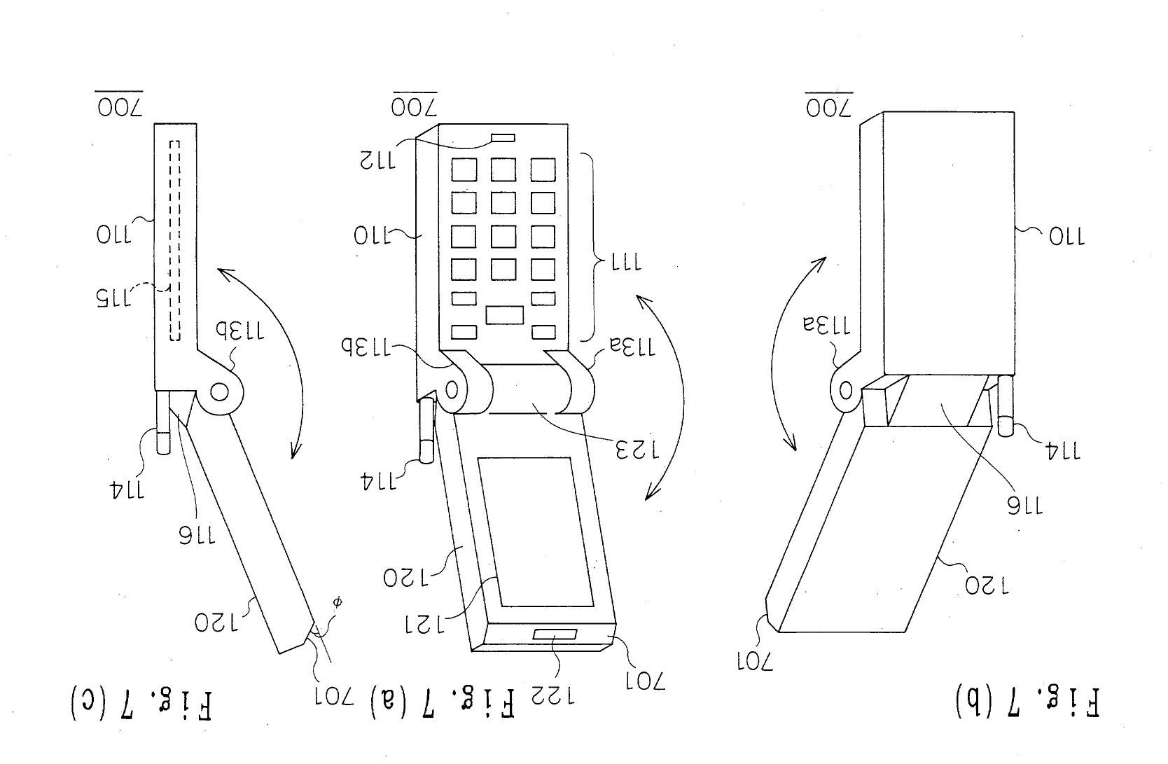

FIGS. 7(a) to 7(c) are block diagrams of a two folding mobile telephone of an embodiment 2 of the present invention. As shown in FIGS. 7 (a) to 7 (c), a portion of the configuration of a two folding mobile telephone 700 same as or corresponding to that in FIG. 1 is provided with the same symbol and its detailed description is omitted.

Moreover, on the inside principal plane of a second housing 120, a partial plane including a voice output plane 122 forms a slope 701 tilted from a plane on which a display screen 121 is formed at a predetermined angle φ.

The two folding mobile telephone of this embodiment having the above configuration is different from a conventional example in that a slope 701 is formed though the angle of aperture between a first housing 110 and the second housing 120 is the same as the case of the conventional example. Advantages of the embodiment 2 are described below.

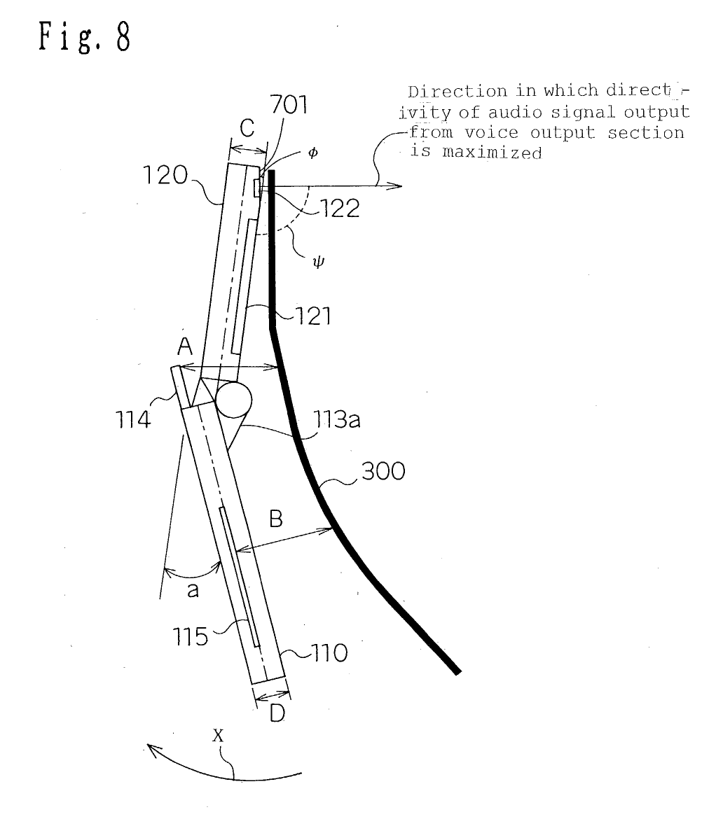

FIG. 8 is an illustration schematically showing a relation between each section of a two folding mobile telephone while operated and the head of a user. Because the correspondence of each symbol showing a distance or dimension is the same as the case of the conventional example shown in FIG. 14(a), detailed description is omitted. Moreover, the angle of aperture formed between the first housing 110 and second housing 120 is substantially 165° which is the same as the case of the conventional example and the angle of depression “a” of the first housing 110 to the second housing 120 shown in FIG. 8 is 15°.

Moreover, in the case of the two folding mobile telephone 700 of this embodiment, the position of an ear of a head 300 and the slope 701 of the second housing 120 are held while they are faced each other substantially in parallel. In the case of the conventional example, the position of the head 300 and the whole inside principal plane of the second housing 120 are held while they are faced each other substantially in parallel (refer to FIG. 14(a)) because the display screen 121 and voice output plane 122 are formed on a uniform inside principal plane in the second housing 120. These holding states are common in that the positional relation between a virtual plane including the voice output plane 122 and the position of the ear of the head 300 is kept substantially in parallel.

This is because of the following reason. That is, when a user applies the voice output plane 122 of the two folding mobile telephone to an ear of the user, the user tries to adjust the ear to the direction in which the directivity of an audio signal output from the voice output plane 122 is maximized. This operation is unconsciously performed in order to listen to an audio signal output from the voice output plane 122 as easily as possible. The virtual plane including the ear is orthogonal to the direction of the directivity of the audio signal and the virtual plane including the voice output plane 122 is also orthogonal to the direction of the directivity of the audio signal. Therefore, the positional relation between the position of the ear and the virtual plane including the voice output plane 122 is kept substantially in parallel.

Therefore, it is possible to adjust the positional relation between the two folding mobile telephone and the head depending on how to set the virtual plane including the voice output plane 122 in the second housing 120. As shown in FIGS. 7(c) and 8, the plane including the display screen 121 tilts from the slope 701 with the voice output plane 122 formed by an angle φ. Therefore, in FIG. 8, the whole two folding mobile telephone opens about an end of the second housing 120 with the slope 701 formed by the angle φ in X direction compared to the case of the conventional example. Thereby, a helical antenna 114 and grounding plate 115 formed on the first housing 110 are spaced away from the head 300 of a user. The direction of the angle φ formed between the direction in which the directivity of an audio signal is maximized and the display screen 121 is set so that the angle φ becomes an obtuse angle.

As shown in FIG. 8, because the embodiment 2 and a conventional example 2 have housings of substantially the same dimensions, distances C and D become equal to each other. As shown by the arrow X in FIG. 8, however, because the angle of aperture from an end of the second housing of this embodiment is larger than the case of the conventional example 2 by the angle φ, distances A and B become larger than the case of the conventional example 2. In the table, the angle φ is set to 2.6°.

Therefore, it is possible to reduce a gain loss β due to the distance B from the grounding plate 115 up to the surface of the head 300 and a gain loss α due to the distance A from the front end of the helical antenna 114 up to the surface of the head 300 and reduce the whole gain loss.

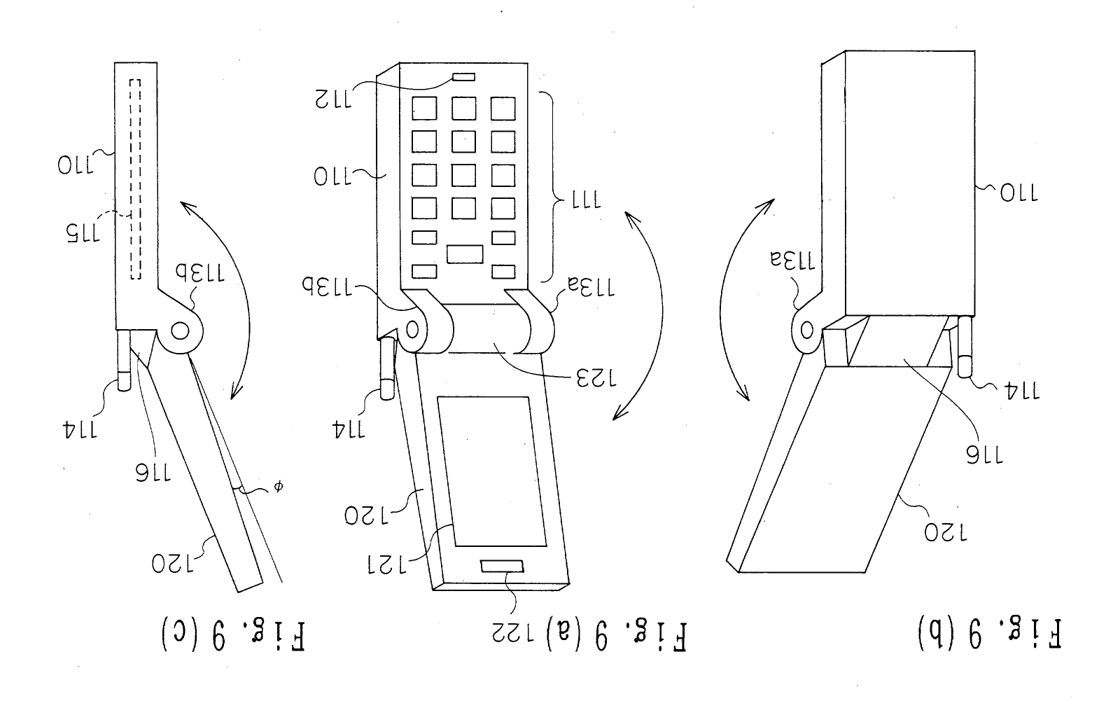

In the above description, only a part of the inside principal plane of the second housing 120 including the voice output plane 122 is formed into a slope so that the slope coincides with a virtual plane orthogonal to a direction in which the directivity of an audio signal output from the voice output plane 122 is maximized. However, it is also allowed to make the virtual plane coincide with the entire inside principal plane of the second housing 120 as shown in FIGS. 9(a) to (c).

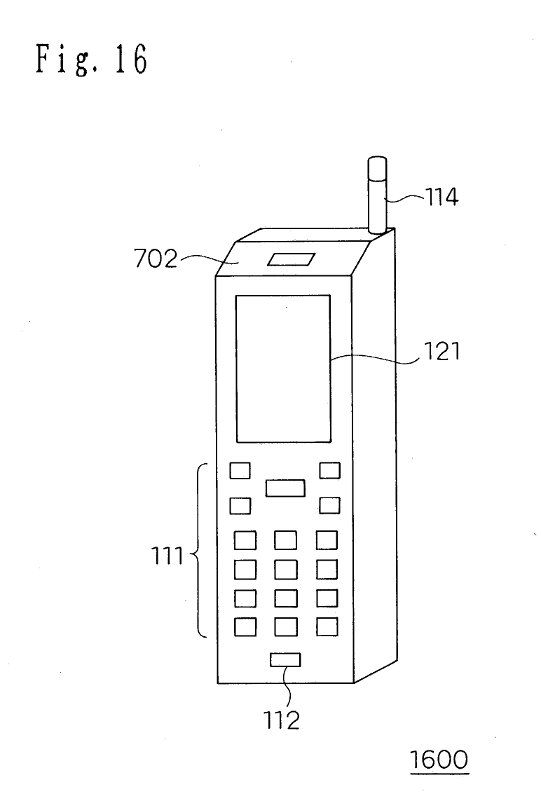

Though the above embodiment is described by using a two folding mobile telephone as an example, it is also allowed to form the configuration of the slope 701 of this embodiment by combining the configuration with a straight mobile telephone which is not the two folding type like the mobile telephone 1600 shown in FIG. 16. In FIG. 16, a portion same as or corresponding to that in FIG. 1 is provided with the same symbol and its detailed description is omitted.

Moreover, it is allowed to form the configuration of the slope 701 of this embodiment by combining the configuration with the configuration of the embodiment 1.

Furthermore, it is according to the invention to combine the configurations of the embodiments 1 and 2.

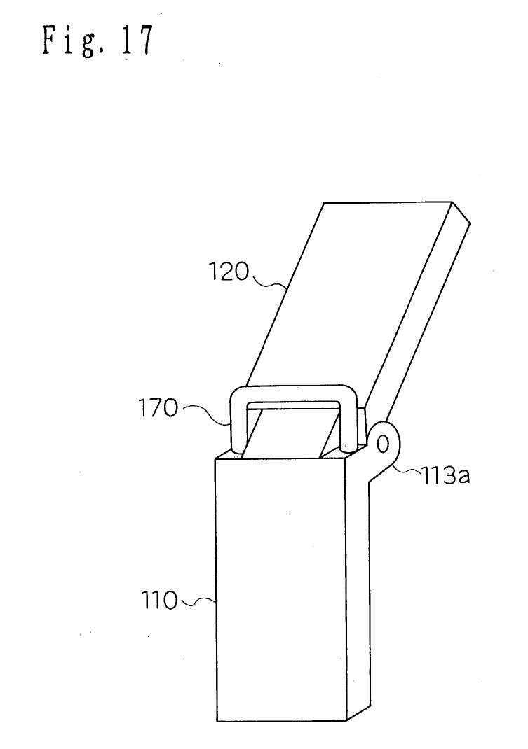

Furthermore, though an antenna of the present invention uses a retractable helical antenna in the case of each embodiment, it is also allowed to use an antenna of another type. For example, it is possible to use the loop antenna 170 set on the first housing 110 shown in FIG. 17.

Furthermore, though a configuration in which the first housing 110 is provided with the antenna 114 and grounding plate 115 is shown for the embodiment 1, it is also allowed to constitute the present invention by setting the grounding plate 115 to the first housing and the antenna 114 to the second housing 120.

Also in the case of the above configuration, by making the angle of aperture between the first housing 110 and second housing 120 larger than 165° of a conventional example, the whole gain is improved because the gain of the grounding plate 115 increases because the board 115 goes away from a human body through the gain decreases because the antenna 114 approaches the human body.

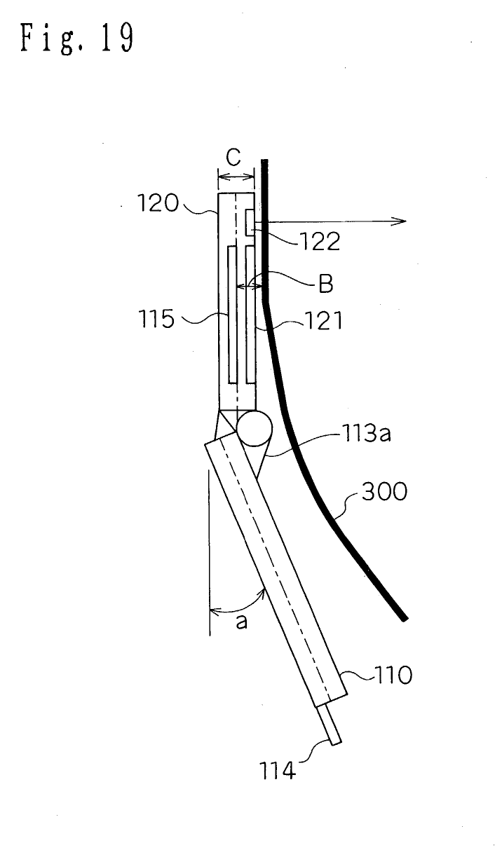

Moreover, as shown in FIG. 19, it is allowed to realize a configuration by setting the antenna 114 to the first housing 110 and the grounding plate 115 to the second housing 120. However, it is different from the embodiment 1 in that the antenna 114 is set not to a hinge bracket 113a but to a position closer to the voice input plane 112.

In the case of the above configuration, by making the angle of aperture between the first housing 110 and second housing 120 larger than substantially 165° of the case of a conventional example, gain is improved because the antenna 114 is spaced away from a human body and the grounding plate 115 approaches the human body. Therefore, the entire gain is improved. In this case, it is allowed to set the antenna 114 to an arbitrary position on the second housing as long as the position is spaced away from a human body when increasing the angle of aperture between the first housing 110 and second housing 120.

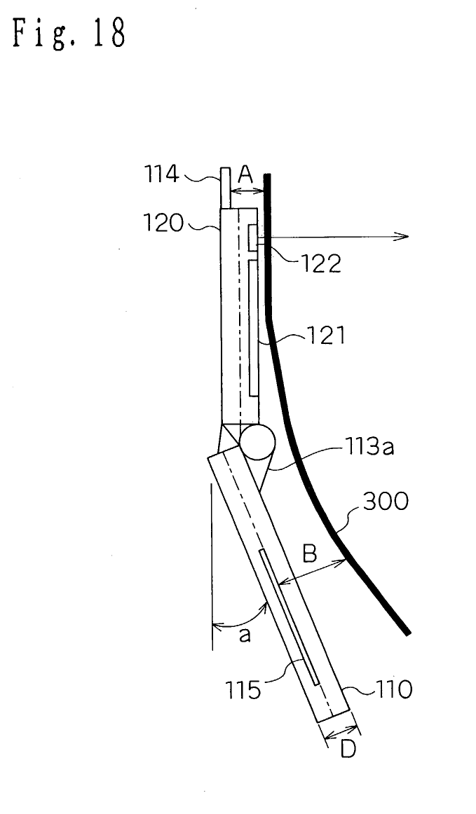

The optimum condition between the antenna and grounding plate shown in FIG. 15 is a condition when both the antenna 114 and grounding plate 115 are set to the first housing but it does not restrict the conditions of the configurations shown in FIGS. 18 and 19.

Moreover, in the case of the embodiment 1, elastic holding means uses the configuration shown in FIG. 4. However, it is also allowed to use another configuration as long as the configuration makes it possible to make an angle of aperture approach a predetermined angle in accordance with an energizing force based on an elastic force.

As described above, according to this embodiment, it is possible to reduce gain loss due to decrease of a mobile telephone in size and thickness.

What is claimed is:

1. A two folding mobile telephone comprising:
a first housing having an antenna, a built-in grounding plate, and a hinge bracket set to an inside principal plane of said first housing;
a second housing having a hinge arm corresponding to said hinge bracket, which is set over at least an end portion, a display screen set to an inside principal plane to display information, and a voice output plane of a loudspeaker opposite to said hinge arm at the both sides of said display screen; and
a fixing mechanism of temporarily fixing said hinge bracket and said hinge arm; wherein,
said first housing and said second housing are connected so that their inside principal planes face each other when closed,
an angle of aperture formed between the inside of a virtual plane orthogonal to the direction when the directivity of an audio signal of said loudspeaker is maximized and the inside of a plane including said grounding plate is held at substantially 165° or larger by temporary fixing by said fixing mechanism, and
said virtual plane is substantially the same as or parallel with a plane including the voice output plane of said loudspeaker and said display screen for displaying information.

2. The two folding mobile telephone according to claim 1, where in,
said fixing mechanism has a stopper set to said first housing and/or said second housing and elastic holding means of holding so that said angle of aperture is held constant by an elastic force,
said elastic holding means provides an energizing force for said angle of aperture to tend to a predetermined first angle,
said stopper is set so that said angle of aperture becomes a second angle smaller than said first angle, and
said second angle is an angle equal to or smaller than a first limit angle at which an allowance accompanying holding by the energizing force of said elastic holding means cannot be permitted.

3. The two folding mobile telephone according to claim 1, wherein,
said fixing mechanism has elastic holding means for holding so that said angle of aperture is kept constant by an elastic force, and
said angle of aperture is equal to or smaller than a second limit angle at which said angle of aperture can be held by said elastic holding means.

4. The two folding mobile telephone according to claim 1, wherein,
said angle of aperture kept by said temporary fixing substantially 166° or larger and 172° or smaller at which said angle of aperture can be held by said temporary fixing.

5. The two folding mobile telephone according to claim 1, wherein,
the inside principal plane of said first housing and the inside principal plane of said second housing have a step when the inside principal plane of said first housing and the inside principal plane of said second housing open so that the angle formed between the inside principal planes of them becomes substantially 180°, and
the inside principal plane of said first housing retreats toward the inside of the housing from the inside principal plane of said second housing.

6. The two folding mobile telephone according to claim 1, wherein,
the average distance between the inside principal plane of said first housing and the outside principal plane opposite to the inside principal plane of said first housing is equal to substantially 7 mm and the average distance between the inside principal plane of said second housing and the outside principal plane opposite to the inside principal plane of said second housing is equal to substantially 9.8 mm.

7. A two folding mobile telephone comprising:
a first housing having an antenna, a built-in grounding plate, and a hinge bracket set to the inside principal plane of said first housing;
a second housing having a hinge arm corresponding to said hinge bracket, which is provided over at least an end portion, a display screen set to an inside principal plane to display information, and a voice output plane of a loudspeaker opposite to the hinge arm at the both sides of said display screen; and
a fixing mechanism of temporarily fixing said hinge bracket and said hinge arm; wherein,
said first housing and said second housing are connected so that their inside principal planes face each other when closed,
a virtual plane orthogonal to a direction when the directivity of an audio signal of said loudspeaker is maximized tilts from a plane including said display screen, and
a direction of said tilt is in a direction in which the direction when the directivity of the audio signal of said loudspeaker is maximized and said display screen form an obtuse angle.

8. A mobile telephone comprising:
a housing having an antenna, a built-in grounding plate, a display screen set to an inside principal plane to display information, and the voice output plane of a loudspeaker, wherein,
a virtual plane orthogonal to a direction in which the directivity of an audio signal of said loudspeaker is maximized tilts from a plane including said display screen, and
a direction of tilt is in a direction in which a direction when the directivity of the audio signal of said loudspeaker is maximized and said display screen form an obtuse angle.

9. The two folding mobile telephone according to claim 7, wherein,
said virtual plane is formed as said voice output plane on the inside principal plane of said first housing.

10. A two folding mobile telephone comprising:
a first housing having a built-in grounding plate and a hinge bracket set on an inside principal plane of said first housing;
a second housing having a hinge arm corresponding to said hinge bracket, provided over at least an end portion, a display screen set to an inside principal plane to display information, a voice output plane of a loudspeaker opposite to said hinge arm at the both sides of said display screen, an antenna; and
a fixing mechanism of temporarily fixing said hinge bracket and said hinge arm; wherein,
said first housing and said second housing are connected so that the housings are faced each other and closed,
an angle of aperture formed between the inside of a virtual plane orthogonal to a direction in which the directivity of the audio signal of said loudspeaker is maximized and the inside of the plane including said grounding plate is held at substantially 165° or larger by temporary fixing by said fixing mechanism, and
said virtual plane is substantially the same as or parallel with a plane including the voice output plane of said loudspeaker and the display screen for displaying information.

11. A two folding mobile telephone comprising:
a first housing having a hinge bracket set to an inside principal plane of said first housing and an antenna;
a second housing having a hinge arm corresponding to said hinge bracket, which is set over at least an end portion, a display screen set to an inside principal plane to display information, a voice output plane of a loudspeaker opposite to said hinge arm at the both sides of said display screen, and a built-in grounding plate; and
a fixing mechanism of temporarily fixing said hinge bracket and said hinge arm; whrein,
said first housing and said second housing are connected so that the inside principal planes of said housings are faced each other and closed,
an angle of aperture formed between the inside of a virtual plane orthogonal to a direction in which the directivity of the audio signal of said loudspeaker is maximized and the inside of a plane including said grounding plate is held at substantially 165° or larger by temporary fixing by said fixing mechanism, and
said virtual plane is substantially the same as or parallel with a plane including the voice output plane of said loudspeaker and said display screen for displaying information.
